(19) United States
(12) Patent Application Publication
(10) Pub. No.: US 2024/0202730 A1
(43) Pub. Date: Jun. 20, 2024

(54) SYSTEMS AND METHODS FOR IDENTIFYING RISKS IN A SALES PIPELINE

(71) Applicant: Dell Products L.P., Round Rock, TX (US)

(72) Inventors: Pratik Jain, Bengaluru (IN); Anna V. Popova, Murphy, TX (US); Vinod Babu Palani, Leander, TX (US); Sudipta Pradhan, Kharagpur (IN)

(21) Appl. No.: 18/083,120

(22) Filed: Dec. 16, 2022

(51) Int. Cl. G06Q 20/40

(52) U.S. Cl. CPC G06Q 20/4016

(57) ABSTRACT

A method for identifying a risk deal in a dynamic sales pipeline, the method that includes selecting, by a risk data generator, a model based on historical accuracy, generating risk data for a sales entry in a dynamic sales pipeline, using the model, making a determination that the risk data indicates a risk deal, and in response to the determination, setting a risk flag in the sales entry.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

FIG. 1 shows a diagram of a virtualized system, in accordance with one or more embodiments.

FIG. 2A shows a diagram of a dynamic sales pipeline database, in accordance with one or more embodiments.

FIG. 2B shows a diagram of a historical sales pipeline database, in accordance with one or more embodiments.

FIG. 2C shows a diagram of a model database, in accordance with one or more embodiments.

FIG. 2D shows a diagram of an identified risks database, in accordance with one or more embodiments.

FIG. 3 shows a diagram of a user interface, in accordance with one or more embodiments.

FIG. 4 shows a flowchart of a method for generating an identified risks entry, in accordance with one or more embodiments.

FIG. 5 shows a diagram of a network and computing device, in accordance with one or more embodiments.

### DETAILED DESCRIPTION

### General Notes

As it is impracticable to disclose every conceivable embodiment of the described technology, the figures, examples, and description provided herein disclose only a limited number of potential embodiments. One of ordinary skill in the art would appreciate that any number of potential variations or modifications may be made to the explicitly disclosed embodiments, and that such alternative embodiments remain within the scope of the broader technology. Accordingly, the scope should be limited only by the attached claims. Further, certain technical details, known to those of ordinary skill in the art, may be omitted for brevity and to avoid cluttering the description of the novel aspects.

For further brevity, descriptions of similarly-named components may be omitted if a description of that similarly-named component exists elsewhere in the application. Accordingly, any component described with regard to a specific figure may be equivalent to one or more similarly-named components shown or described in any other figure, and each component incorporates the description of every similarly-named component provided in the application (unless explicitly noted otherwise). A description of any component is to be interpreted as an optional embodiment-which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any particular ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” is used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for interaction in some way (e.g., via the exchange of information). For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

### Overview and Advantages

In general, this application discloses one or more embodiments of systems and methods for identifying sales deals that are “at-risk” of not closing (i.e., not receiving a commitment to purchase from the buyer). Further, one or more embodiments herein provides the rationale (e.g., the “risk factors”) for the ‘at-risk’ designation and provides actions that may be taken to mitigate those identified risks.

In general, as a business operates, revenue and margin are generated and tracked in “quarters” of the year (a three-month period). Accordingly, much of the determination of potential risks and opportunities are identified and tracked “by quarter”. This evaluation often revolves around key issues, such as: (i) estimating how much revenue is likely to be generated by the end of the quarter, (ii) identifying sales that diverge from their estimated revenue, (iii) attainment (revenue divided by revenue target), (iv) identifying the risks in meeting the revenue target, (v) estimating demand in the pipeline to meet the revenue target, and (vi) in the event of a risk, quantifying the additional demand needed to mitigate the identified risks.

Often businesses already measure and store a vast amount of data that can provide significant insight into the ongoing operations of the business (and the aid the evaluation of the above-mentioned factors). By applying data science techniques to this data, businesses can extract revenue trends and patterns and use them to better predict revenue (e.g., generate more accurate forecasts), thereby helping sales teams to be better prepared to handle potential gaps in meeting revenue targets.

Further, engineering this data can help businesses derive quantitative factors impacting revenue. By understanding the key factors that drive revenue, businesses can make better informed decisions about how to mitigate potential risks and capitalize on opportunities. This data can also be wielded to quantify risk and risk mitigation measures, allowing businesses to better understand the potential impact of different risks and how to address those risks.

The data elements that are most useful for determining specific actions to mitigate sales risk vary depending on the specific business and its operations. Generally, factors that are most critical to meeting a revenue target include (i) target for the current quarter, (ii) sufficiency of current deals in the sales pipeline to meet the target, (iii) percentage of the sales pipeline at risk, (iv) identifying deals that need additional attention, (v) factors contributing to risk deals, and (vi) actions needed to avert risk deals. Accordingly, by identifying the data elements that are most relevant to the business, a sales team can be better equipped to handle potential risks and work towards meeting revenue targets.

Ultimately, the revenue target for a sales region (and the business overall) is composed of the individual sales targets for respective sales representatives (and sales managers). Accordingly, each sales representative builds a sales pipeline to engage demand and meet their revenue target for a given quarter. To satisfy a revenue target, it is important to evaluate a sales pipeline for sales opportunities/deals in advance, activate sales representatives on specific opportunities for specific customers, and mitigate any risk factors that may prevent a deal from moving forward.

One major reason for the sales deals failing to close is the lack of a system which can predict risk factors for a deal that considers both (i) data patterns, and (ii) human intelligence. Further, even with such information, risk identification needs to be provided early in the quarter in order to provide a sales representative with sufficient time to mitigate the risks. Otherwise, by the time the sales representative becomes aware of any risk to an ongoing deal, it may be too late to mitigate the loss of that deal.

As discussed in more detail herein, an end-to-end machine learning solution is used to predict the likelihood of deals that are ‘at-risk’ of not proceeding (to close) on their respective scheduled date. As used herein, deals that are identified as “at-risk”, “risky”, or having sufficient risk (e.g., surpassing a threshold) are called “risk deals”. Key factors, termed as “risk factors”, contributing to risk deals are derived through methods of explainable artificial intelligence. Such analysis aids sales representatives in having a better understanding of risk drivers and to work with their managers and customers to mitigate the potential risks on time

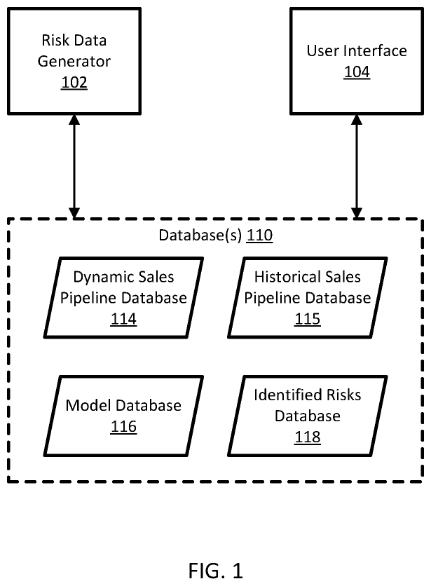

### FIG. 1

FIG. 1 shows a diagram of a virtualized system, in accordance with one or more embodiments. In one or more embodiments, a virtualized system may include one or more software entities (e.g., a risk data generator (102), a user interface (104)) and one or more database(s) (110). Each of these components is described below.

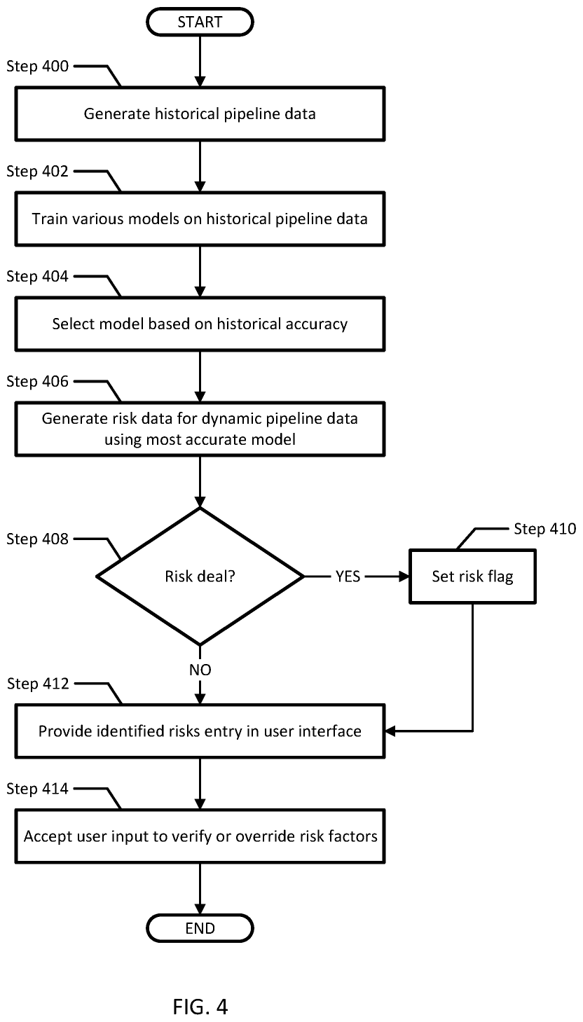

In one or more embodiments, a risk data generator (102) is software, executing on a computing device, which generates risk data (in the identified risk database (118)) by using one or more models (from the model database (116)) to analyze sales pipeline data (from the dynamic sales pipeline database (114)). Additional details regarding the functions of the risk data generator (102) may be found in the description of FIG. 4.

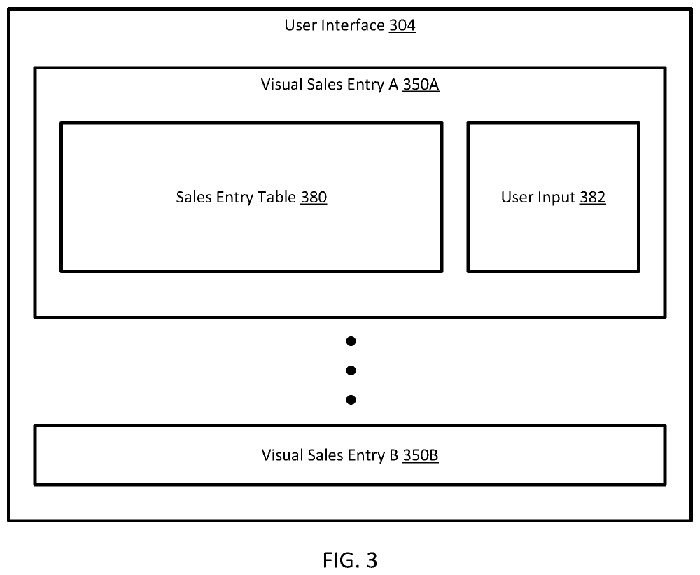

In one or more embodiments, a user interface (104) is software, executing on a computing device. In one or more embodiments, a user interface (104) allows one or more user(s) of the computing device to view, interact with, and/or modify data of the dynamic sales pipeline database (114). Additional details regarding the functions of the user interface (104) may be found in the description of FIG. 3.

In one or more embodiments, a database (e.g., database(s) (110)) is a collection of data stored on a computing device, which may be grouped (physically or logically). Non-limiting examples of a database (110) include (i) a dynamic sales pipeline database (114), (ii) a historical sales pipeline database (115), (iii) a model database (116), and (iv) an identified risks database (118).

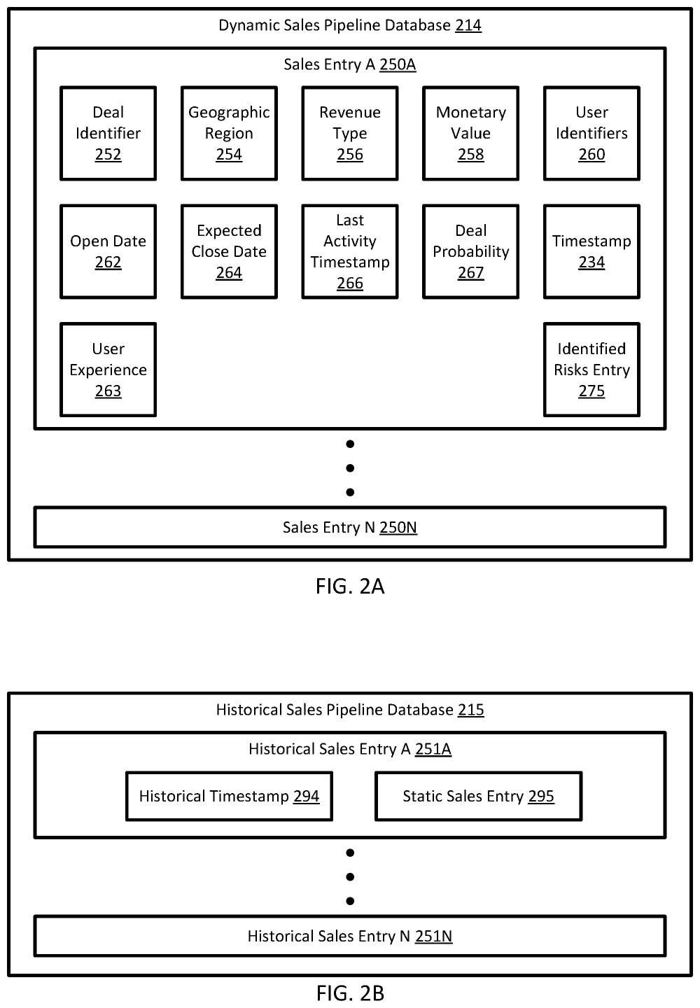

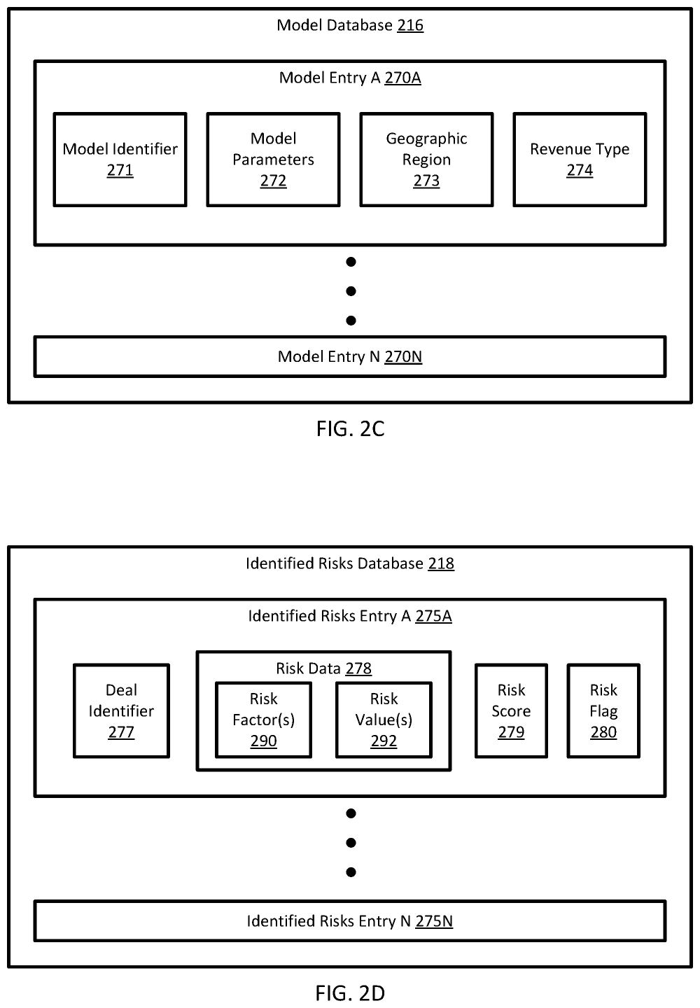

Although the databases (110) are shown as four distinct entities, any combination of two or more of the databases (110) be combined into a single database that includes some or all of the data of any of the individual databases. Additional details regarding the individual databases (110) may be found in the description of FIGS. 2A-2D.

While a specific configuration of a system is shown, other configurations may be used without departing from the disclosed embodiment. Accordingly, embodiments disclosed herein should not be limited to the configuration of devices and/or components shown.

### FIG. 2A

FIG. 2A shows a diagram of a dynamic sales pipeline database, in accordance with one or more embodiments. In one or more embodiments, a dynamic sales pipeline database (214) is a data structure that includes one or more sales entries (e.g., sales entry A (250A), sales entry N (250N)). In one or more embodiments, a dynamic sales pipeline database (214) is “dynamic” because any sales entry (250) therein is continually and automatically updated with new data, as that data arrives. That is, for example, if the monetary value (258) of a deal changes, the value in the respective sales entry (250) may be updated individually thereafter (i.e., not waiting for a push of multiple simultaneous updates scheduled to occur at once).

In one or more embodiments, a sales entry (250) is a data structure that may include (or otherwise be associated with):
(i) a deal identifier (252) that uniquely identifies a single deal associated with the sales entry (250) (non-limiting examples of an identifier include a tag, an alphanumeric entry, a filename, and a row number in table),
(ii) a timestamp (234) that provides a date/time for the sales entry (250) (e.g., January 1, 17:00, 1669830702). In one or more embodiments, the timestamp (234) may be set at the last time the sales entry (250) (e.g., any data therein) was modified (e.g., updated),
(iii) a geographic region (254) that indicates the geographic territory associated with the sales entry (250) (e.g., North America (NA), Asia-Pacific-Japan (APJ), Texas, Paris, 123 main street, etc.). As a non-limiting example, if the geographic region is “India”, the sales entry (250) would pertain to a sales deal emanating from India,
(iv) a revenue type (256) relating to the category of revenue associated with the sales entry (250) (e.g., retail, enterprise sales, run rate, bid size, etc.),
(v) a monetary value (258) that equals the potential revenue that would be generated if the deal associated with the sales entry (250) is fulfilled,
(vi) user identifier(s) (260) that uniquely identifies one or more user account(s) that are able to access (read) and/or edit (write) the associated sales entry (250),
(vii) an open date (262) that is the date/time when the deal associated with the sales entry (250) was initiated (e.g., when a bid was offered, when a request-for-quote was received, etc.). In one or more embodiments, the open date (262) may be the date/time when the sales entry (250) was created,
(viii) an expected close date (264) that is the date/time when the potential deal associated with the sales entry (250) is expected to “close” (i.e., receive a commitment to purchase from the buyer),
(ix) a last activity timestamp (266) that is the date/time when the last action for the deal was performed (e.g., an initial bid, an updated quote request, a notice that the seller is advancing in the bid process, etc.),
(x) a deal probability (267) that represents the likelihood that the deal will “close” (which may be calculated automatically, or input by a human),
(xi) a user experience (263) that indicates the level of experience of one or more user(s) (e.g., work duration experience, deal was shifted to new user, etc.),
(xii) an identified risks entry (275) that is associated with the sales entry (250). In one or more embodiments, the identified risks entry (275) is dynamically pulled from the identified risk database (218) such that any changes made to the identified risks entry (275) (in the identified risk database (218)) are automatically updated in the sales entry (250), and conversely, any changes made to the identified risks entry (275) (in the sales entry (250)) are automatically updated in the identified risk database (218), or
(xiii) any combination thereof.

In one or more embodiments, as used herein, “dynamic sales pipeline data” means the data within any one sales entry (250). In one or more embodiments, as used herein, “dynamic sales pipeline dataset” means one or more sales entries (250).

### FIG. 2B

FIG. 2B shows a diagram of a historical sales pipeline database, in accordance with one or more embodiments. In one or more embodiments, a historical sales pipeline database (215) is a data structure that includes one or more historical sales entries (e.g., historical sales entry A (251A), historical sales entry N (251N)). In one or more embodiments, a historical sales pipeline database (215) is “historical” because it includes past “snapshots” (copied data) of the dynamic sales pipeline database (214). In one or more embodiments, each historical sales entry (251) respectively corresponds to a single sales entry (250) as that sales entry (250) existed at some point in the past (e.g., at the time of the historical timestamp (294)).

In one or more embodiments, a historical sales entry (251) is a data structure that may include (or otherwise be associated with):
(i) a historical timestamp (294) that provides a date/time for when the associated static sales entry (295) was accurate (e.g., having data that was “current” at the time of the historical timestamp (294)). In one or more embodiments, the historical timestamp (294) may be the date/time of when the snapshot/copy of the sales entry (250) was created. In one or more embodiments, the historical timestamp (294) matches the last activity timestamp (266) included in the static sales entry (295);
(ii) a static sales entry (295) that is a “snapshot” (i.e., copy) of a sales entry (250) (from the dynamic sales pipeline database (214)) as the sales entry (250) existed at the time of the historical timestamp (294). That is, in one or more embodiments, the static sales entry (295) is not updated to reflect the current status of the deal, but remains static (e.g., “fixed”, “constant”, “read-only”), or
(iii) any combination thereof.

### FIG. 2C

FIG. 2C shows a diagram of a model database, in accordance with one or more embodiments. In one or more embodiments, a model database (216) is a data structure that includes one or more model entries (e.g., model entry A (270A), model entry N (270N)). In one or more embodiments, a model entry (270) is a data structure that may include (or otherwise be associated with):
(i) a model identifier (271) that uniquely identifies a model,
(ii) a set of model parameters (272) (described below),
(iii) a geographic region (273) (same description as geographic region (236)),
(iv) a revenue type (274) (same description as revenue type (238)), or
(v) any combination thereof.

In one or more embodiments, model parameters (272) provide instructions (to the risk data generator) on how to calculate and identify relevant risk data (278). In one or more embodiments, the model parameters (272) may specify one or more machine learning techniques. Non-limiting examples of machine learning techniques include (i) distributed random forest, (ii) any neural network, (iii) logistic regression, (iv) K-nearest neighbor, and (v) extreme gradient boosting (XGboost). In one or more embodiments, model parameters (272) may be “trained” by the risk data generator using the historical sales pipeline database (215).

In one or more embodiments, as used herein, “model” means the data within any one model entry (270).

### FIG. 2D

FIG. 2D shows a diagram of an identified risks database, in accordance with one or more embodiments. In one or more embodiments, an identified risk database (218) is a data structure that includes one or more identified risks entries (e.g., identified risks entry A (275A), identified risks entry N (275N)). In one or more embodiments, an identified risks entry (275) is a data structure that may include (or otherwise be associated with):
(i) a deal identifier (277) that uniquely associates the identified risks entry (275) with a sales entry (250) or historical sales entry (251) (that includes the same matching deal identifier (252)),
(ii) risk data (278) (described below),
(iii) a risk score (279) that is a composite (e.g., aggregated) value calculated from the risk value(s) (292) of the risk data (278).
(iv) a risk flag (280) that is a binary indication of whether the associated sales entry (250) (or historical sales entry (251)) is considered a “risk deal”, or
(v) any combination thereof.

In one or more embodiments, risk data (278) is data that includes one or more risk factor(s) (290), identified in the associated sales entry (250), associated with one or more risk value(s) (292). In one or more embodiments, a risk factor (290) is data specifying an identified risk in the sales entry. Non-limiting examples of a risk factor (290) include (i) age of the deal (i.e., duration since the open date (262)), (ii) decrease in monetary value (258), (iii) inactivity duration (i.e., duration since last activity timestamp (266) surpasses a threshold) (e.g., one month with no activity), (iv) multiple changes to the expected close date (264), (v) low user experience (e.g., sales representative has only been in the current position for three months), (vi) or any other factor that may be determined from the data available in the sales entry (250).

In one or more embodiments, a risk value (292) is a numerical score assigned to each risk factor (290). A risk value (292) is a quantitative measure of the “risk” of the associated with the risk factor (290). As a non-limiting example, if a risk factor (290) is present because the age of the deal is 300 days old, there may be an associated risk factor of “5”. Similarly, if there is a risk factor (290) is present because the age of the deal is 600 days old, there may be an associated risk factor of “10”. As another non-limiting example, a risk factor (290) indicating that that the expected close date (264) was moved back one day, may have an associated risk value (292) of “1”, whereas a risk factor (290) indicating that that the expected close date (264) was moved back one month, may have an associated risk value (292) of “25”. Accordingly, in one or more embodiments, a risk factor (290) that indicates more “risk” is assigned a higher risk value (292).

### FIG. 3

FIG. 3 shows a diagram of a user interface, in accordance with one or more embodiments. In one or more embodiments, a user interface (304) is software (executing on a computing device) that generates one or more visual element(s) (i.e., the components of user interface (304)) and allows one or more user(s) of the computing device to interact, view, and/or control the visual element(s) displayed in the user interface (304).

In one or more embodiments, a user interface (304) includes one or more visual sales entries (e.g., visual sales entry A (350A), visual sales entry B (350B)) that are uniquely associated with a sales entry in the dynamic sales pipeline database. Each visual sales entry (350) may include a sales entry table (380) that provides a visual representation of data from the associated sales entry (e.g., a column for each component, and the associated values in a shared row). In one or more embodiments, the sales entry table (380) may be a single row in table, where labeled columns are shared among all visual sales entries (350).

In one or more embodiments, a visual sales entry (350) includes a user input (382) where a user of the user interface (304) may input data (e.g., an alphanumeric string) that is saved to the associated sales entry (or saved to identified risks entry associated with the associated sales entry). In one or more embodiments, the user input (382) may provide a button to toggle the risk flag (e.g., on, off) in the associated sales entry. Any changes made in the user input (382) may be saved to the associated sales entry in the dynamic sales pipeline database.

While a specific configuration of a user interface is shown, other configurations may be used without departing from the disclosed embodiment. Accordingly, embodiments disclosed herein should not be limited to the configuration of devices and/or components shown.

### FIG. 4

FIG. 4 shows a flowchart of a method for generating an identified risks entry, in accordance with one or more embodiments. All or a portion of the method shown may be performed by one or more components of the virtual system (e.g., the risk data generator). However, another component of the virtual system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 400, the risk data generator generates historical pipeline data. In one or more embodiments, the risk data generator generates historical pipeline data by aggregating “snapshots” (copied data) of the dynamic sales pipeline database at regular intervals (e.g., every day, week, month, etc.) and storing those snapshots into the historical sales pipeline database.

In one or more embodiments, each snapshot of a single sales entry generates a corresponding single historical sales entry. Additionally, in one or more embodiments, as multiple snapshots are taken of the dynamic sales pipeline over time, multiple historical sales entries for a single deal (having a matching deal identifier) are generated, but including varying historical timestamps.

In one or more embodiments, the risk data generator may (i) capture the snapshot (of the dynamic sales pipeline database) at the regular intervals, (ii) copy existing backup data of the dynamic sales pipeline database, or (iii) use some combination thereof.

In Step 402, the risk data generator generates multiple identified risk datasets using multiple (respective) models from the model database. In one or more embodiments, each analysis is trained using a single deal over time. That is, when the model is trained by the risk data generator, multiple historical sales entries are identified that each have the same deal identifier, but having different historical timestamps. Further, as the same deal is used for multiple analyses, the geographic region and revenue type are consistent throughout, as well.

As a non-limiting example, for any set of historical sales entries (with a matching deal identifier), the risk data generator generates a first set of identified risks entries using XGboost, then generates a second set of identified risks entries (for the same historical sales entries) using K-nearest neighbor, then generates a third set of identified risks entries (for the same historical sales entries) using logistic regression, etc. Accordingly, a variety of identified risks entries (each using different techniques) are available for the same underlying historical sales entries.

In one or more embodiments, user input is used to train the models in the model database. That is, as the user input is recorded in the dynamic sales pipeline (via the inclusion of the associated identified risks entries), the data is available to the risk data generator when a snapshot is taken. Accordingly, user overrides of risk flag statuses are used to more accurately train the models. That is, as a non-limiting example, a model may provide a false positive that a deal is at risk (which is later ‘confirmed’ by a delay in the deal). However, the sales entry may include a user override indicating that the deal was not at risk (despite the subsequent delay). Accordingly, a variant of the model (or a different) that does not set a risk flag for that deal would ultimately be considered more accurate (at least, in that instance) because the user override is given more weight (e.g., considered “correct” for training purposes).

Further, in one or more embodiments, the risk data generator may perform sentiment analysis on any alphanumeric string provided in the user input to identify additional risk data. That is, the risk data generator may search for keywords (e.g., “insolvency”, “bankruptcy”, “failed payment”) to identify additional risk that is not available in the raw data of the sales entry. In turn, models are trained to use sentiment analysis to predict future risk deals.

In Step 404, the risk data generator selects the model that generated the most accurate risk data. In one or more embodiments, the risk data generator compares the deals identified as “risk deals” (with a set risk flag, at some point in time) and identifies if the deal later (i) had a postponement (a delay in the estimated closing date), or (ii) did not proceed and no purchase was made. If either of those conditions are met, the deal is considered a “risk deal”. In instances where a user override of the risk flag is present, the user override is given considerably more weight as “correct” than a subsequent delay in the estimated closing date. Accordingly, the model that correctly generated the most risk flags prior to a deal being delayed or canceled is selected as the most accurate model.

In Step 406, the risk data generator uses the selected model to generate risk data for one or more sales entries in the dynamic sales pipeline. In one or more embodiments, the risk data generator generates a risk score by aggregating the risk values (of the risk data) into a single composite score. As a non-limiting example, each risk value may be weighted, summed, averaged, and otherwise aggregated together to calculate a composite risk score.

In Step 408, the risk data generator makes a determination as to whether the risk score exceeds a threshold for determining whether the sales entry is at risk (and the risk flag should be set). In one or more embodiments, the composite risk score calculated in Step 406 provides a single score that can be compared against a threshold to determine if the overall risk for the sales entry.

If the risk data generator determines that risk score exceeds the threshold (Step 408-YES), the method proceeds to Step 410. However, if the risk data generator determines that risk score does not exceed the threshold (Step 408-NO), the method proceeds to Step 412.

In Step 410, the risk data generator sets the risk flag in the identified risks entry. In one or more embodiments, the risk data generator sets the flag by modifying the identified risks entry to indicate the risk status of the sales entry.

In Step 412, the risk data generator provides the identified risks entry to the user interface. In one or more embodiments, the risk data generator provides the identified risks entry to the user interface by saving a copy of the identified risks entry in the associated sales entry (which is already available in the user interface).

In one or more embodiments, the identified risks entry is automatically available in the user interface via its association with the sales entry. That is, as each sales entry is already accessible in the user interface, the identified risks entry may be made available via the inclusion of the same deal identifier. Accordingly, any modifications to the identified risks entry are automatically and instantly viewable in the user interface.

In Step 414, the risk data generator accepts user input from the user interface. In one or more embodiments, the risk data generator monitors the identified risks entry for changes made by a user, and if detected, the risk data generator uses the updated risks data entry for further training of the models in the model database (e.g., as snapshots of the sales entry are created).

As a non-limiting example, a sales deal may be identified as a risk deal because the expected closing date of the deal was pushed back. Accordingly, the risk flag (in identified risks entry) is set and a user (e.g., a sales representative) sees the risk flag when using the user interface. In turn, the user analyses the rationale for the risk flag status, by reading the risk factors (of the risk data) and seeing that the shifted closing date is the cause of the risk flag status. However, the user manually turns off the risk flag to indicate that deal is not at risk. Further, the user provides an alphanumeric explanation in the user input that explains why the deal is not at risk (e.g., “Buyer moved expected purchase date back one day because initial date was a Monday holiday. Nothing else has changed and the deal is not at risk.”).

As another non-limiting example, a sales deal may not be identified as a risk deal because the sales entry did not include data to indicate sufficient risk. However, the sales representative (associated with the sales entry) is informed that the buyer's company may be facing financial issues and that other sellers have been receiving cancelations for their orders from the same buyer. As a result, the buyer changes the risk status to “risky” and provides an alphanumeric explanation saying, “Buyer may be facing financial issues, yet to confirm”.

In turn, any updates (made by the user) are saved to the associated identified risks entries. And, as discussed in Step 402, the user input is used to more accurately train the models in the model database.

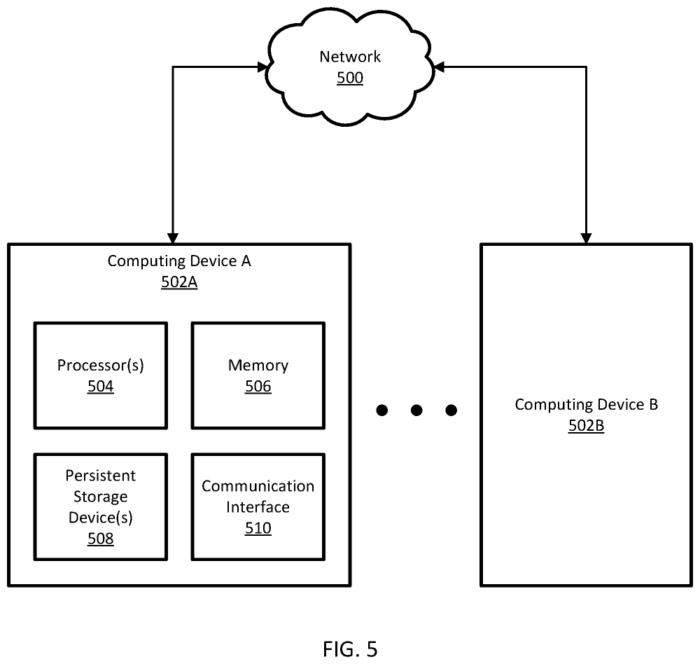

### FIG. 5

FIG. 5 shows a diagram of a network and computing device, in accordance with one or more embodiments. In one or more embodiments, a system may include a network (500) and one or more computing device(s) (502). Each of these components is described below.

In one or more embodiments, a network (e.g., network (500)) is a collection of connected network devices (not shown) that allow for the communication of data from one network device to other network devices, or the sharing of resources among network devices. Non-limiting examples of a network (e.g., network (500)) include a local area network (LAN), a wide area network (WAN) (e.g., the Internet), a mobile network, any combination thereof, or any other type of network that allows for the communication of data and sharing of resources among network devices and/or computing devices (502) operatively connected to the network (500). One of ordinary skill in the art, having the benefit of this detailed description, would appreciate that a network is a collection of operatively connected computing devices that enables communication between those computing devices.

In one or more embodiments, a computing device (e.g., computing device A (502A), computing device B (502B)) is hardware that includes any one, or combination, of the following components:
(i) processor(s) (504),
(ii) memory (506) (volatile and/or non-volatile),
(iii) persistent storage device(s) (508),
(iv) communication interface(s) (510) (e.g., network ports, small form-factor pluggable (SFP) ports, wireless network devices, etc.),
(v) internal physical interface(s) (e.g., serial advanced technology attachment (SATA) ports, peripheral component interconnect (PCI) ports, PCI express (PCIe) ports, next generation form factor (NGFF) ports, M.2 ports, etc.),
(vi) external physical interface(s) (e.g., universal serial bus (USB) ports, recommended standard (RS) serial ports, audio/visual ports, etc.), or
(vii) input and output device(s) (e.g., mouse, keyboard, monitor, other human interface devices, compact disc (CD) drive, other non-transitory computer readable medium (CRM) drives).

Non-limiting examples of a computing device (502) include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device (502) with the aforementioned capabilities. In one or more embodiments, a computing device (502) may be operatively connected to another computing device (502) via a network (500).

As used herein, “software” means any set of instructions, code, and/or algorithms that are used by a computing device (502) to perform one or more specific task(s), function(s) or process(es). A computing device (502) may execute software (e.g., via processor(s) (504) and memory (506)) which read and write to data stored on one or more persistent storage device(s) (508) and memory (506). Software may utilize resources from one or more computing device(s) (502) simultaneously and may move between computing devices, as commanded (e.g., via network (500)). Additionally, multiple software instances may execute on a single computing device (502) simultaneously.

In one or more embodiments, a processor (e.g., processor (504)) is an integrated circuit for processing computer instructions. In one or more embodiments, a persistent storage device(s) (508) (and/or memory (506)) may store software that is executed by the processor(s) (504). A processor (504) may be one or more processor cores or processor micro-cores.

In one or more embodiments, memory (e.g., memory (506)) is one or more hardware devices capable of storing digital information (e.g., data) in a non-transitory medium. In one or more embodiments, when accessing memory (506), software may be capable of reading and writing data at the smallest units of data normally accessible (e.g., “bytes”). Specifically, in one or more embodiments, memory (506) may include a unique physical address for each byte stored thereon, thereby enabling software to access and manipulate data stored in memory (506) by directing commands to a physical address of memory (506) that is associated with a byte of data (e.g., via a virtual-to-physical address mapping).

In one or more embodiments, a persistent storage device (e.g., persistent storage device(s) (508)) is one or more hardware devices capable of storing digital information (e.g., data) in a non-transitory medium. Non-limiting examples of a persistent storage device (508) include integrated circuit storage devices (e.g., solid-state drive (SSD), Non-Volatile Memory Express (NVMe), flash memory, etc.), magnetic storage (e.g., hard disk drive (HDD), floppy disk, tape, diskette, etc.), or optical media (e.g., compact disc (CD), digital versatile disc (DVD), etc.). In one or more embodiments, prior to reading and/or manipulating data located on a persistent storage device (508), data may first be required to be copied in “blocks” (instead of “bytes”) to other, intermediary storage mediums (e.g., memory (506)) where the data can then be accessed in “bytes”.

In one or more embodiments, a communication interface (e.g., communication interface (510)) is a hardware component that provides capabilities to interface a computing device with one or more devices (e.g., through a network (500) to another computing device (502), another server, a network of devices, etc.) and allow for the transmission and receipt of data with those devices. A communication interface (510) may communicate via any suitable form of wired interface (e.g., Ethernet, fiber optic, serial communication etc.) and/or wireless interface and utilize one or more protocols for the transmission and receipt of data (e.g., transmission control protocol (TCP)/internet protocol (IP), remote direct memory access (RDMA), Institute of Electrical and Electronics Engineers (IEEE) 801.11, etc.).

While a specific configuration of a system is shown, other configurations may be used without departing from the disclosed embodiment. Accordingly, embodiments disclosed herein should not be limited to the configuration of devices and/or components shown.

What is claimed is:

1. A method for identifying a risk deal in a dynamic sales pipeline, the method comprising:
selecting, by a risk data generator, a model based on historical accuracy;
generating risk data for a sales entry in a dynamic sales pipeline, using the model;
making a determination that the risk data indicates a risk deal; and
in response to the determination:
setting a risk flag in the sales entry.

2. The method of claim 1, wherein prior to selecting the model, the method further comprises:
generating historical pipeline data comprising user input;
training a plurality of models using the historical pipeline data, wherein the plurality of models comprises the model; and
identifying, based on the training, the model as the most accurate model.

3. The method of claim 2, wherein training the plurality of models, comprises:
generating a plurality of identified risks datasets using the plurality of models, respectively;
analyzing the identified risks datasets to calculate a plurality of historical accuracies, respectively, wherein the plurality of historical accuracies comprises the historical accuracy; and
identifying the historical accuracy as the most accurate, wherein the historical accuracy is calculated using the model.

4. The method of claim 1, wherein generating the risk data, comprises:
analyzing the sales entry to identify a risk factor; and
assigning a risk value to the risk factor, wherein the risk data comprises the risk value and the risk factor.

5. The method of claim 4, wherein making the determination that the risk data indicates the risk deal, comprises:
determining that the risk value is greater than a threshold.

6. The method of claim 1, wherein after setting the risk flag, the method further comprises:
providing the risk data in a user interface.

7. The method of claim 6, wherein after providing the risk data in the user interface, the method further comprises:
receiving user input, in the user interface, from a user; and
saving the user input in the sales entry.

8. The method of claim 7, wherein the user input unsets the risk flag.

9. A non-transitory computer readable medium comprising instructions which, when executed by a processor, enables the processor to perform a method for identifying a risk deal in a dynamic sales pipeline, the method comprising:
selecting, by a risk data generator, a model based on historical accuracy;
generating risk data for a sales entry in a dynamic sales pipeline, using the model;
making a determination that the risk data indicates a risk deal; and
in response to the determination:
setting a risk flag in the sales entry.

10. The non-transitory computer readable medium of claim 9, wherein prior to selecting the model, the method further comprises:
generating historical pipeline data comprising user input;
training a plurality of models using the historical pipeline data, wherein the plurality of models comprises the model; and
identifying, based on the training, the model as the most accurate model.

11. The non-transitory computer readable medium of claim 10, wherein training the plurality of models, comprises:
generating a plurality of identified risks datasets using the plurality of models, respectively;
analyzing the identified risks datasets to calculate a plurality of historical accuracies, respectively, wherein the plurality of historical accuracies comprises the historical accuracy; and
identifying the historical accuracy as the most accurate, wherein the historical accuracy is calculated using the model.

12. The non-transitory computer readable medium of claim 9, wherein generating the risk data, comprises:
analyzing the sales entry to identify a risk factor; and
assigning a risk value to the risk factor, wherein the risk data comprises the risk value and the risk factor.

13. The non-transitory computer readable medium of claim 12, wherein making the determination that the risk data indicates the risk deal, comprises:
determining that the risk value is greater than a threshold.

14. The non-transitory computer readable medium of claim 9, wherein after setting the risk flag, the method further comprises:
providing the risk data in a user interface.

15. The non-transitory computer readable medium of claim 14, wherein after providing the risk data in the user interface, the method further comprises:
receiving user input, in the user interface, from a user; and
saving the user input in the sales entry.

16. The non-transitory computer readable medium of claim 15, wherein the user input unsets the risk flag.

17. A computing device, comprising:
a processor; and
memory storing instructions which, when executed by the processor, enables the processor to perform a method for identifying a risk deal in a dynamic sales pipeline, the method comprising:
selecting, by a risk data generator, a model based on historical accuracy;
generating risk data for a sales entry in the dynamic sales pipeline, using the model;
making a determination that the risk data indicates the risk deal; and
in response to the determination:
setting a risk flag in the sales entry.

18. The computing device of claim 17, wherein prior to selecting the model, the method further comprises:
generating historical pipeline data comprising user input;
training a plurality of models using the historical pipeline data, wherein the plurality of models comprises the model; and
identifying, based on the training, the model as the most accurate model.

19. The computing device of claim 18, wherein training the plurality of models, comprises:
generating a plurality of identified risks datasets using the plurality of models, respectively;
analyzing the identified risks datasets to calculate a plurality of historical accuracies, respectively, wherein the plurality of historical accuracies comprises the historical accuracy; and
identifying the historical accuracy as the most accurate, wherein the historical accuracy is calculated using the model.

20. The computing device of claim 17, wherein generating the risk data, comprises:
analyzing the sales entry to identify a risk factor; and
assigning a risk value to the risk factor, wherein the risk data comprises the risk value and the risk factor.
